(19) United States
(12) Patent Application Publication
(10) Pub. No.: US 2003/0096132 A1
(43) Pub. Date: May 22, 2003

(54) PVC/wood fiber composite

(76) Inventor: Mark P. Richardson, Glencoe (CA)

Correspondence Address: COGNIS CORPORATION, 2500 RENAISSANCE BLVD., SUITE 200, GULPH MILLS, PA, 19406

(21) Appl. No.: 10/278,152

(22) Filed: Oct. 21, 2002

Related U.S. Application Data
(60) Provisional application No. 60/343,654, filed on Oct. 25, 2001.

(51) Int. Cl. B32B 27/42

(52) U.S. Cl. 428/528; 428/537.1; 428/479.6

(57) ABSTRACT

PVC/wood fiber composites are comprised of (1) wood fibers; and (2) a composite comprising PVC, a polyester and a lubricant package comprised of one or more polyol esters, polyols, fatty acid esters of aliphatic or aromatic dicarboxylic acids, fatty acid salts, fatty alcohols, hydrogenated fatty acid glycerides and combinations thereof. The composites are easier to process than conventional composites because they require lower extruder torque that translates into less work and corresponds to lower process temperatures.

### CROSS REFERENCE TO RELATED APPLICATIONS

This application claims the benefit of copending provisional application serial No. 60/343,654, filed on Oct. 25, 2001, the entire contents of which are incorporated herein by reference.

### BACKGROUND OF THE INVENTION

Wood fibers have been used as economical fillers for polyolefins and polyvinyl chloride (PVC) for about 30 years. The recent popularity is due to the shortage of raw timber and the restrictions put on the saw dust producing industry. When it comes to compounding wood fibers there are several alternatives that can be adjusted to the unique requirements of such a filled system.

### BRIEF SUMMARY OF THE INVENTION

The present invention relates to a wood fiber/PVC composite comprising: (1) wood fibers; and (2) a composite comprising PVC, a polyester plasticizer and a lubricant package comprised of one or more polyol esters, polyols, fatty acid esters of aliphatic or aromatic dicarboxylic acids, fatty acid salts, fatty alcohols, hydrogenated fatty acid glycerides and combinations thereof.

The invention also relates to a method of making a wood fiber/PVC composite comprising mixing: (1) wood fibers; and (2) a composite comprising PVC, a polyester plasticizer and a lubricant package comprised of one or more polyol esters, polyols, fatty acid esters of aliphatic or aromatic dicarboxylic acids, fatty acid salts, fatty alcohols, hydrogenated fatty acid glycerides and combinations thereof.

The wood fiber/PVC composite according to the invention contains a polymeric plasticizer in combination with a lubricant package. The polymeric plasticizer is a polyester that acts as a wetting agent that allows for a greater degree of dispersion of the wood fiber. It is well known that the degree of dispersion is linked to the gelation properties of the compound and the percent moisture retained after the incorporation of the materials in the blend cycle. The PVC/wood composites according to the invention are easier to process than conventional composites because they require lower extruder torque that translates into less work and corresponds to lower process temperatures.

### DETAILED DESCRIPTION OF THE INVENTION

The wood composite according to the invention can contain from about 30% to about 70% by weight of wood fiber and from about 30% to about 70% by weight of a composite comprised of a mixture of PVC, impact modifiers such as standard acrylic impact modifiers, process aids, and heat stabilizers such as a tin stabilizer, one or more polyesters according to the invention and a lubricant package as described herein. The wood fibers can be any type of wood fibers such as, for example, saw dust or wood flour or combinations of different types of wood fibers.

The polyesters according to the invention can be made by reaction of a one or more dicarboxylic acids, one or more glycols and in some cases a quantity of monobasic acid or monofunctional alcohol. Preferably, the polyesters according to the invention are those that contains a quantity of a monobasic acid or a monofunctional alcohol sufficient to produce an average molecular weight ranging from about 850 to about 5,000. Dicarboxylic acids useful in the formation of the polymeric plasticizers are aliphatic dicarboxylic acids having from about 4 to 18 carbon atoms. Representative aliphatic dicarboxylic acids of the above types include, but are not limited to, glutaric acid, succinic acid, adipic acid, pimelic acid, suberic acid, azelaic acid, sebacic acid and dodecanedioic acid. Derivatives of dicarboxylic acids can also be used such as acid anhydrides and esters. Small amounts of acid impurities, such as aromatic dicarboxylic acids, may be present without significantly affecting the overall properties of the plasticizers. Adipic acid, azelaic acid and sebacic acid are especially useful for the present invention because of their commercial availability and the superior characteristics i.e., ready compatability with the PVC without destroying the processing characteristics of the PVC and little or no tendency to migrate.

The glycols according to the invention are linear or branched aliphatic diols having from 3 to 10 carbon atoms. The hydroxyl groups may be either primary or secondary. Useful glycols of the above type include: 2-hydroxymethyl-2-methylpropyl-2-hydroxymethyl-2-methylpropionate (hereinafter referred to as ester-diol), neopentyl glycol, 2-methyl-1,3-propane diol, 3-methyl-1,5-pentane diol, 2,2,4-trimethyl-1,3-pentane diol, 2,3-dimethyl-2,3-butane diol, 1,2-propylene glycol, 1,3-butylene glycol, 1,2-butanediol, 1,2-pentanediol, 1,3-pentanediol, 1,4-pentanediol, and the like. It is not necessary that the glycol charge consist of branched-chain diols. Other glycols which can be included in the diol charge are linear aliphatic primary glycols containing from about 2 to 12 carbon atoms, such as ethylene glycol, 1,3-propylene glycol, 1,4-butylene glycol and the like.

To realize plasticizers having the desired balance of migration properties and compatibility with PVC and which have molecular weights in the above defined ranges, it may require either monobasic acid or monofunctional alcohol be employed as a chain terminator. These monocarboxylic acids will contain from about 6 to about 20 carbon atoms. They may additionally contain aromatic monocarbocyclic acids with one or more other substituents on the aromatic nucleus such as alkyl, nitro, halo, alkoxyl and acyl groups. Typical monobasic acids include caprylic acid, pelargonic acid, capric acid, lauric acid, myristic acid, palmitic acid, stearic acid, coconut acid and the like. Typical monobasic aromatic acids of the above types include benzoic acid, the toluic acids, the nitrobenzoic acids, the methoxybenzoic acids, the chlorobenzoic acids and the like. Alcohols used as terminating agents will contain between 4 and 16 carbon atoms and may be linear or branched chain alcohols. Some representative monofunctional alcohols include n-butanol, n-hexanol, 7,9 Alcohol, 8,10 Alcohol, Isodecyl alcohol, tridecyl alcohol, 2-ethyl hexanol and the like. The amount of polyester in the wood composite according to the invention can range from about 1.5 to about 3.0 parts by weight of the composite.

The lubricant package is comprised of one or more polyol esters, polyols, fatty acid esters of aliphatic or aromatic dicarboxylic acids, fatty acid salts, fatty alcohols, hydrogenated fatty acid glycerides and combinations thereof. The polyol ester can be any ester formed by reaction of a polyol such as, for example, neopentyl glycol, trimethylolpropane, pentaerythritol, di-pentaerythritol and a monocarboxylic acid having from 1 to 22 carbon atoms. These esters can be made by standard methods known to those skilled in the art such as the method described in U.S. Pat. No. 5,021,179, the entire contents of which are incorporated herein by reference. The polyols can be any aliphatic polyfunctional alcohol such as ethylene or propylene glycol, neopentyl glycol, trimethylolpropane, pentaerythritol, di-pentaerythritol and a monocarboxylic acid having from 1 to 22 carbon atoms. The fatty acid esters of dicarboxylic acids can be esters of C₈₋₂₂ fatty acids and any aliphatic or aromatic dicarboxylic acid such as, for example, adipic acid, phthalic acid, azelaic acid, and the like. A fatty acid salt is any alkali metal or alkaline earth metal salt of a C₈₋₂₂ fatty acid such as, for example, the calcium salt of stearic acid. The fatty alcohol can be any C₈₋₂₂ linear or branched aliphatic alcohol such as, for example, tallow fatty alcohol. The hydrogenated fatty acid glyceride can be any hydrogenated mono-, di-, and/or triglyceride of a fatty acid such as, for example, a hydrogenated tallow glyceride. The lubricant package can contain any combination of the foregoing components. The amount of the lubricant package in the wood composite according to the invention can range from about 2 to about 3.5 parts by weight of the composite.

A composite according to the invention is typically made by blending in a high intensity mixer the PVC resin+acrylic modifier+tin stabilizer+polyester plasticizer+lubricant package. The mixture is heated to a bowl temperature of about 150° F. The wood fiber is added to the high intensity mixer @ 150° F. and heated to a bowl temperature of 190° F. The steam is then shut off and the composite is heated to a temperature of 211° F.±4° F. Water is circulated to cool the high intensity mixer and @ 200° F. The Titanium Dioxide and Calcium carbonate are added and blended to a bowl temperature of 150° F. Then the hot mixer gate is opened to allow for the composite to flow into a holding vessel.

The following examples are meant to illustrate but not to limit the invention.

### EXAMPLE 1

The wood composite composition was prepared by mixing 60.6% by weight of PVC resin, 24.2% by weight of wood flour, 3.6% TiO2 and filler, 3.9% by weight of acrylic impact modifier, process aid, 2.3% by weight of a lubricant^{A}, 1.8 % by weight polyester plasticizer and 0.66% by weight tin stabilizer blended in a high intensity mixer to a temperature of 212° F.±3° F. Gelation time was measured on a Brabender PL 2000 bowl temperature of 185° C. and a rotor speed of 60 rpm and a 65 gram charge. Moisture % was calculated after drying the composite for ½ hour in a oven for 0.5 hours.

A-Lubricant composition (parts by weight on total composite weight) −0.2 parts stearic acid; 0.3 parts of a C₁₈ carboxylic acid ester of pentaerythritol; 1 part of a C₁₈ carboxylic acid ester of di-pentaerythritol.

### EXAMPLE 2

The reaction of the dicarboxylic acid, branched-chain glycol and, if needed, terminator to obtain the desired polyester plasticizer compositions is carried out in conventional equipment using established esterification procedures. The reactants are added to a suitable esterification kettle as a unit charge. The reaction is then typically heated at a temperature from about 150° C. to about 250° C. at atmospheric pressure for a period of time sufficient to substantially complete the esterification, usually about 3 to 8 hours. The reaction is generally conducted to an acid value less than about 10 and acid values of 5 or below are even more preferred. The rate of esterification can be enhanced by the use of suitable esterification catalysts such as phosphoric acid, sulfuric acid, p-toluene sulfonic acid, methane sulfonic acid, stannous oxalate, alkyl tin oxides, tetrabutyl titanate, zinc acetate, sodium carbonate and the like. The amount and type of catalyst can be widely varied, however, most often the amount of catalyst will range from about 0.1 to about 1.0% by weight of the total reactant charge. At the completion of reaction the catalyst may be deactivated or removed by filtering or other conventional means. While the reaction may be conducted entirely at atmospheric pressure, it is generally more desirable to apply a vacuum (typically 2-50 mm Hg at 200°-250° C.) to the system during the latter stages of the reaction. This is particularly advantageous if low acid values are to be obtained. It also facilitates removal of any excess glycol and small amounts of other volatile materials which may be present.

Inert diluents such as benzene, toluene, xylene and the like can be employed in carrying out the reaction but they are not necessary. In fact, it is generally considered desirable to conduct the reaction without diluents since the polymeric plasticizer is then suitable for use as it is obtained from the esterification reactor.

While the practice of charging the reactants to form the polyesters will vary, it is preferred that the dibasic acid, glycols, and terminator be charged to the reactor with a small excess (based on the stoichiometric or equivalent amount calculated for the acid present) of the glycol and alcohol component. The excess glycol serves as the reaction medium and is distilled off as the esterification reaction is carried to completion. The removed glycol may be recycled to the esterification reactor, if desired. Usually 24% by weight excess glycol (above theory) will suffice for this purpose, however, more can be utilized if desired. Following the above procedure should result in a polyester suitable for the present invention.

### EXAMPLE 3

| | Brabender PL 2000 | | | | | |
|---|---|---|---|---|---|---|
| | (185° C., 60 rpm, 65 g) | | | | | |
| Fusion Test | 1 | 2 | 3 | 4 | 5 | 6 |
| Fusion Time | 116 | 96 | 114 | 104 | 106 | |
| (sec) | | | | | | |
| Fus. Torque | 3611 | 3700 | 3490 | 3688 | 3543 | |
| (mg) | | | | | | |
| Eq. Torque | 2224 | 2605 | 2545 | 2662 | 2572 | Wood |
| (mg) | | | | | | |
| Eq. Temp | 204 | 208 | 205 | 207 | 206 | filler |
| (° C.) | | | | | | |
| % b Moisture | 0.32 | 0.75 | 0.53 | 0.59 | 0.53 | 4.78 |

Formulation 1: consists of PVC, wood filler, a simple paraffin wax MP 65-75° C. @ 1 PHR of total formulation and an oxidized polyethylene MP range of 110 @ 0.15 PHR.

Formulation 2: consists of PVC, wood filler, distearyl phthalate, MP of 44-47° C. @ 0.5 PHR and a lubricant comprised of calcium hydroxide, stearic acid, tallow fatty alcohol, hydrogenated tallow glyceride and a thermal stabilizer having a MP of 110-115° C. @ 1.4P and 3.0 PHR, a polyester of adipic acid, 1,3-butanediol and 2-ethylhexanoic acid.

Formulation 3: consists of PVC, wood filler, distearyl phthalate, MP of 44-47° C. @ 0.5 PHR and stearic acid, MP of 54-56° C. @ 0.2P and a lubricant comprised of calcium hydroxide, stearic acid, tallow fatty alcohol, hydrogenated tallow glyceride and a thermal stabilizer having a MP of 110-115° C. @ 1.4P and 3.0 PHR of a polyester of adipic acid, 1,3-butanediol and 2-ethylhexanoic acid.

Formulation 4: consists of PVC, wood filler, distearyl phalate, MP of 44-47° C. @ 0.7 and pentaerythritol @ 0.4 PHR and 3.0 PHR of a polyester of adipic acid, 1,3-butanediol and 2-ethylhexanoic acid.

Formulation 5: consists of PVC, wood filler, distearyl phalate, MP of 44-47° C. @ 0.5 PHR and a lubricant comprised of calcium hydroxide, stearic acid, tallow fatty alcohol, hydrogenated tallow glyceride and a thermal stabilizer having a MP of 110-115° C. @ 1.2P and pentaerythritol @ 0.4 PHR and 3.0 PHR of a polyester of adipic acid, 1,3-butanediol and 2-ethylhexanoic acid.

What is claimed is:

1. A PVC/wood fiber composite comprising: (1) wood fibers; and (2) a composite comprising PVC, a polyester and a lubricant package comprised of one or more polyol esters, polyols, fatty acid esters of aliphatic or aromatic dicarboxylic acids, fatty acid salts, fatty alcohols, hydrogenated fatty acid glycerides and combinations thereof.

2. The composite of claim 1 wherein the lubricant package is comprised of distearyl phthalate and pentaerythritol.

3. The composite of claim 1 wherein the polyol ester is a monocarboxylic acid ester of neopentyl glycol, trimethylolpropane, pentaerythritol or di-pentaerythritol wherein the monocarboxylic acid has from 1 to 22 carbon atoms.

4. The composite of claim 1 wherein the polyester is an ester of an aliphatic dicarboxylic acid having from 4 to 18 carbon atoms and a linear or branched aliphatic diol having from 3 to 10 carbon atoms.

5. The composite of claim 1 wherein the dicarboxylic acid is selected from the group consisting of glutaric acid, succinic acid, adipic acid, pimelic acid, suberic acid, azelaic acid, sebacic acid, dodecanedioic acid and mixtures thereof.

6. The composite of claim 4 wherein the diol is selected from the group consisting of ethylene glycol, 1,3-propylene glycol, 1,4-butylene glycol, 2-hydroxymethyl-2-methylpropyl-2-hydroxymethyl-2-methylpropionate, neopentyl glycol, 2-methyl-1,3-propane diol, 3-methyl-1,5-pentane diol, 2,2,4-trimethyl-1,3-pentane diol, 2,3-dimethyl-2,3-butane diol, 1,2-propylene glycol, 1,3-butylene glycol, 1,2-butanediol, 1,2-pentanediol, 1,3-pentanediol, 1,4-pentanediol and mixtures thereof.

7. The composite of claim 1 wherein the molecular weight of the polyester is from about 850 to about 5,000.

8. The composite of claim 1 further comprising an impact modifier, a processing aid, and a heat stabilizer.

9. A method of making a PVC/wood fiber composite comprising mixing (1) wood fibers; and (2) a composite comprising PVC, a polyester and a lubricant package comprised of one or more polyol esters, polyols, fatty acid esters of aliphatic or aromatic dicarboxylic acids, fatty acid salts, fatty alcohols, hydrogenated fatty acid glycerides and combinations thereof.
